(19) United States
(12) Patent Application Publication
(10) Pub. No.: US 2026/0368549 A1
(43) Pub. Date: Nov. 19, 2026

(54) Automated Deductive Reasoning of Propositional Logic in Natural Deduction

(71) Applicant: Oracle International Corporation, Redwood Shores, CA (US)

(72) Inventors: Dharmalingam GANESAN, Crofton, MD (US); David M. CLIFTON, Ellicott City, MD (US)

(21) Appl. No.: 19/209,923

(22) Filed: May 16, 2025

(51) Int. Cl. G06N 5/01

(52) U.S. Cl. CPC G06N 5/013

(57) ABSTRACT

Embodiments generate a proof of a problem. Embodiments receive a set of premises, a corresponding conclusion, a set of rules, and a maximum proof length. Embodiments model each step of the proof as a variable and represent each of the set of rules as a constraint. Embodiments delegate the constraints to a specialized constraint solver and when the specialized constraint solver determines a solution that simultaneous satisfies the constraints, extract the proof, where the proof comprises a sequence of steps and rule names.

### FIELD

One embodiment is directed generally to a computer system, and in particular to a computer system performing deductive reasoning.

### BACKGROUND INFORMATION

Natural deduction is a method used in formal logic to derive conclusions from premises using a set of logical rules that closely resemble the way humans typically reason. Natural deduction is a way of proving the validity of arguments step by step, based on logical connectives such as logical AND (\hat{ }), OR (v), IMPLIES (→), NOT (¬ or ~) and contradiction (⊥). Propositional logic in natural deduction refers to using the natural deduction system to reason formally with propositions (i.e., statements that are either true or false) connected by the logical connectives.

Similarly, deductive reasoning is a logical process in which a conclusion is drawn necessarily from a set of premises. If the premises are true and the reasoning is valid, then the conclusion must also be true. Automated deductive reasoning is the use of computer programs to perform the deductive reasoning, or to automatically derive logical conclusions from a set of premises using formal rules of logic.

### SUMMARY

Embodiments generate a proof of a problem. Embodiments receive a set of premises, a corresponding conclusion, a set of rules, and a maximum proof length. Embodiments model each step of the proof as a variable and represent each of the set of rules as a constraint. Embodiments delegate the constraints to a specialized constraint solver and when the specialized constraint solver determines a solution that simultaneous satisfies the constraints, extract the proof, where the proof comprises a sequence of steps and rule names.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates an example of a system that includes an automated deductive reasoning system in accordance to embodiments.

FIG. 2 is a block diagram of the automated deductive reasoning system of FIG. 1 in the form of a computer server/system in accordance to an embodiment of the present invention.

FIG. 3 is a flow diagram of the functionality of the automated deductive reasoning system of FIG. 1 when performing deductive reasoning in accordance to embodiments.

FIGS. 4-7 illustrate an example cloud infrastructure that can implement the automated deductive reasoning system of FIG. 1 in accordance to embodiments.

### DETAILED DESCRIPTION

Embodiments provide automated deductive reasoning by modeling each step of a potential proof as a variable, and representing logical rules as constraints among the variables. Embodiments use a constraint solver that determines if all constraints can be satisfied simultaneously. If the solver finds a solution, a compete proof is automatically extracted.

Deductive or logical reasoning plays a pivotal role in many real-world domains, such as chatbot, explainable artificial intelligence (“AI”), software program correctness, etc. In these domains, a valid argument is created from some premises to reach a conclusion. Given a set of premises and a conclusion, embodiments automatically generate a sequence of steps, by applying the rules or axioms of the given logical framework, to reach the conclusion.

For example, assume a puzzle is needed to be solved, where there is a need to find a path from the starting point to the goal. Traditionally, a known solution might explore one path at a time, backtracking when it hits dead ends. However, this trial-and-error approach can be time-consuming, especially when the search space is large. In contrast, embodiments implement a constraint-based proof search method that takes a fundamentally different approach. Instead of exploring one path at a time, embodiments transform the entire problem into a set of rules and relationships. To generate a proof, embodiments model each step of the potential proof as a variable, and logical rules are represented as constraints among these variables. Embodiments delegate this system of constraints to a specialized constraint solver that can efficiently determine if all constraints can be satisfied simultaneously. If the solver finds a solution, a complete proof is extracted. If not, embodiments determine that no proof exists, within the specified configuration.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

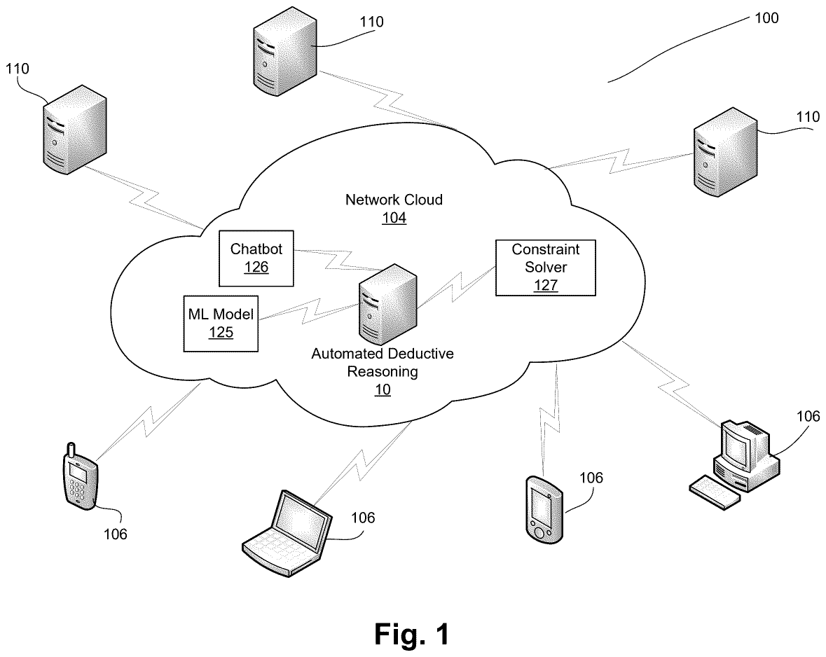

FIG. 1 illustrates an example of a system 100 that includes an automated deductive reasoning system 10 in accordance to embodiments. Automated deductive reasoning system 10 may be implemented within a computing environment that includes a communication network/cloud 104. Network 104 may be a private network that can communicate with a public network (e.g., the Internet) to access additional services 110 provided by a cloud services provider. Examples of communication networks include a mobile network, a wireless network, a cellular network, a local area network (“LAN”), a wide area network (“WAN”), other wireless communication networks, or combinations of these and other networks. Automated deductive reasoning system 10 may be administered by a service provider, such as via the Oracle Cloud Infrastructure (“OCI”) from Oracle Corp.

Tenants of the cloud services provider can be companies or any type of organization or groups whose members include users of services offered by the service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 106, which can be any type of device that can access network 104 and can obtain the benefits of the functionality of automated deductive reasoning system 10 for performing deductive reasoning. As disclosed herein, a “client” (also disclosed as a “client system” or a “client device”) may be a device or an application executing on a device. System 100 includes a number of different types of client devices 106 that each is able to communicate with network 104.

Executing on cloud 104 (or otherwise in communication with automated deductive reasoning system 10, including on-premises) in one embodiment is at least one machine learning (“ML”) model 125, such as a generative model, neural network, deep learning, support vector machine (“SVM”), random forest, gradient boosting, large language model (“LLM”), etc.). ML model 125 may generate “hallucinations” that refers to when a machine learning model, particularly an LLM, produces incorrect or nonsensical information, often presented with confidence as if it were true. This phenomenon can occur due to limitations in training data, understanding context, or the inherent nature of ML models. Automated deductive reasoning system 10 in embodiments can determine/explain the cause of AI hallucination, and prevent future occurrences.

Further executing on cloud 104 (or otherwise in communication with automated deductive reasoning system 10, including on-premises) in one embodiment is at least one chatbot 126. A chatbot is a computer program designed to simulate human conversation, typically through text or voice interfaces. They can automate tasks, provide information, and engage with users in a conversational manner. Chatbots are increasingly used in customer service, sales, and various other applications to enhance user experience and streamline operations. Chatbots, similar to ML models, hallucinate. Automated deductive reasoning system 10 in embodiments can determine/explain the cause of chatbot hallucination, and prevent future occurrences.

Further executing on cloud 104 (or otherwise in communication with automated deductive reasoning system 10, including on-premises) is at least one constraint solver 127. A constraint solver is a computational tool or algorithm used to find solutions to problems defined by a set of constraints (i.e., rules or conditions that variables must satisfy). In one embodiment, constraint solver 127 is a satisfiability modulo theories (“SMT”) solver, which is a solver that determines whether a mathematical formula is satisfiable.

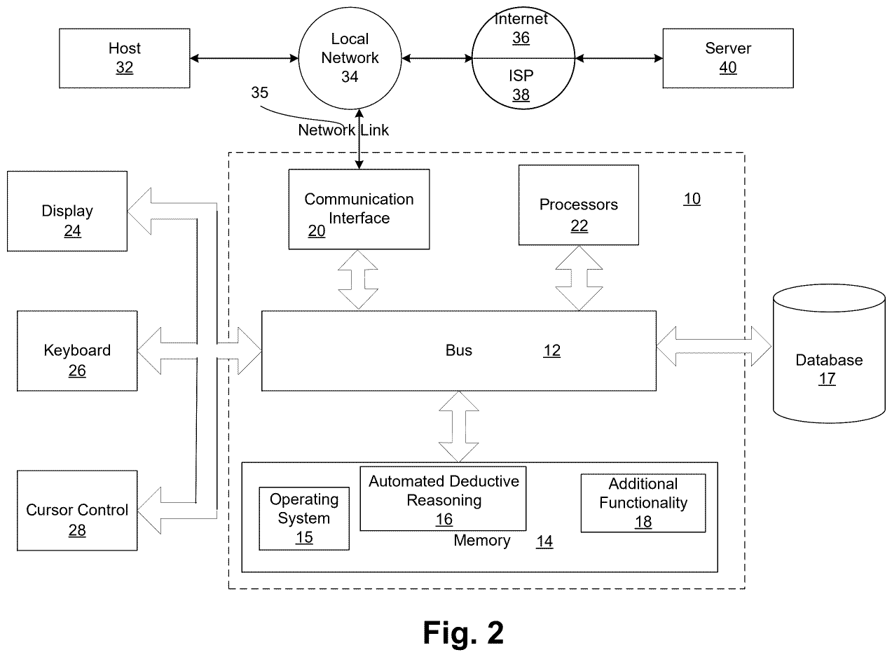

FIG. 2 is a block diagram of automated deductive reasoning system 10 of FIG. 1 in the form of a computer server/system 10 in accordance to an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, transitory and non-transitory media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an automated deductive reasoning module 16 that provides automated deductive reasoning, and all other functionality disclosed herein. System 10 can be part of a larger system. Therefore, system 10 can include one or more additional functional modules 18, such as an ML model or chatbot that utilizes the automated deductive reasoning functionality. A file storage device or database 17 is coupled to bus 12 to provide centralized storage for modules 16 and 18, including training data used to generate ML models. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 10, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

As disclosed, automated deductive reasoning is the use of computer programs to perform the deductive reasoning, or to automatically derive logical conclusions from a set of premises using formal rules of logic. One known solution, referred to as “Tableau Methods”, focuses on semantic model building rather than producing structured proofs, and lacks support for hierarchical proof structures. Further, the Tableau Methods cannot be configured to employ an allowed list of axioms. Another known solution, referred to as “Resolution” provers, uses a single calculus optimized for machine efficiency with no notion of sub-proofs or scoped assumptions, in contrast to embodiments of the invention. Neither Tableau Methods and Resolution provers can consider human provided hints or verify whether existing proofs are correct. Their proofs usually are structured by enumerating different possibilities and proving backwards using proof-by-contradiction.

Another known solution, using SMT solvers (e.g., the “Z3 Theorem Prover”), verifies formulas rather than constructing step-by-step proofs, and cannot incorporate manual steps. They prove theorem using proof-by-contradiction, which is not always the preferred way of constructing proofs. Proof by contradiction is a logical method where a statement is proven true by demonstrating that assuming it is false leads to a contradiction. This method is also known as “reductio ad absurdum.” For example, SMT solvers can prove that (A or B) implies (B or A) and output the proof as follows:
unit-resolution(asserted(Or(A, B)),
   not-or-elim(asserted(Not(Or(B, A))), Not(A)),
   not-or-elim(asserted(Not(Or(B, A))), Not(B)),
   False)
      The “False” at the last line indicate that proof-by-contradiction is employed for proving this theorem. These types of proofs are generally for machines to process, but do not necessarily reflect the way humans perform reasoning and write proofs.

In contrast, embodiments generate constructive proofs, not just proof-by-contradiction alone. The same theorem as above is instead proved by embodiments in a constructive style with assumptions and employing relevant rules of the natural deduction framework for propositional logic as follows:
Searching proof for: A v B |-B v A
Premises:
   (A v B)
Goal: (B v A)
Length: 8
Found proof:
Step 0:(A v B) [premise]
Step 1:|A [assumption]
Step 2:|(B v A) [v-i-L using 1]
Step 3:(A−>(B v A)) [−>i using 1-2]
Step 4:|B [assumption]
Step 5:|(B v A) [v-i-R using 4]
Step 6:(B−>(B v A)) [−>i using 4-5]
Step 7:(B v A) [v-e using 0,3,6]

In general, with traditional known SMT-based verification approaches, when the SMT solver directly proves a theorem, it typically generates resolution proofs or model-based evidence that is essentially unreadable to humans. These proofs generally: (a) use low-level logical calculi optimized for machine efficiency rather than human understanding; (b) often involve thousands or millions of elementary steps with no discernible high-level structure; (c) provide little insight into the conceptual reasoning behind the proof; (d) cannot be translated into standard mathematical notation in any straightforward way; and (e) are practically unusable for educational purposes or mathematical communication.

Further, known automated natural deduction systems typically use search heuristics that cannot guarantee minimal proofs and struggle with complex scoping rules. For example, the “Logic Theorist” (“LT”), which is a known software program that performs logical processes on logical expressions, generates proofs by performing custom search using several heuristic techniques. Because of heuristic based proof search, the LT cannot prove several theorems that require automatically generating intermediate assumption formulas.

The description of LT notes that they cannot prove some class of logical problems that are beyond the scope of their heuristics. For example, it discloses that LT cannot prove a logical formula P Or (Not(Not(Not(P)))) is valid, where P is a proposition. In contrast, embodiments can prove this theorem because embodiments are fundamentally different by using constraint-based proof generation, instead of custom heuristic techniques as in LT. The proof, according to embodiments, is as follows:
Premises:
Goal: (p v~~~p)
Length: 9
Found proof:
Step 0:|p [assumption]
Step 1:|(p v~~~p) [v-i-R using 0]
Step 2:(p−>(p v~~~p)) [−>i using 0-1]
Step 3:|~(p v~~~p) [assumption]
Step 4:|~p [MT using 2,3]
Step 5:|~~~p [~~i using 4]
Step 6:|(p v~~~p) [v-i-L using 5]
Step 7:|#[~e using 6,3]
Step 8: (p v~~~p) [pbc using 3-7]

As a simplified example of how embodiments of the invention are implemented, consider the following logical problem:

“If the train arrives late and there are no taxis at the station, then John is late for his meeting. John is not late for his meeting. The train did arrive late. Therefore, there were taxis at the station.”

In symbolic reasoning, such statements can be represented using symbols, for example, as follows:
P: Train arrives late.
Q: Taxis at the station.
R: Late for meeting.
   Where the theorem is: If P and not Q, then R. Not R. P. Therefore, Q.

Embodiments are directed with automatically proving such theorems for logical reasoning purposes. For example, based on the symbolic encoding of the above logical problem, embodiments automatically generate a proof for humans to understand and verify that the conclusion can be derived from the given premises. In embodiments, the human-readability of the generated proofs, in contrast to known solutions, is a core property for explainable AI or symbolic reasoning.

The proof shown below, generated by embodiments, show that the conclusion Q is indeed reachable from the given premises of the logical puzzle in 9 steps as the proof length. Moreover, the proof shows that each step is also automatically annotated with previous step numbers and the relevant axioms such as And introduction (\hat{ }i), Implies elimination (→e), double not elimination (~~e), to name a few. Embodiments can also handle a hierarchy of sub-proofs by creating a box (shown as a vertical line) from lines step 3 through step 6, as well as symbolically generate formulas for assumptions (see step 3) which are often required in proving logical formulas that involve the logical OR operator.
Premises:
   ((P \hat{ }~Q)−>R)
   ~R
   P
Goal: Q
Length: 9
Found proof:
Step 0:((P \hat{ }~Q)−>R) [premise]
Step 1:~R [premise]
Step 2:P [premise]
Step 3:|~Q [assumption]
Step 4:|(P \hat{ }~Q) [using 2,3]
Step 5:|R [−>e using 0,4]
Step 6:|#[~e using 5,1]
Step 7:~~Q [~i using 3-6]
Step 8:Q [~~e using 7]

Embodiments of the invention are rooted in solving the Boolean satisfiability problem: given a Boolean formula, is it possible to assign truth values (true or false) to the variables in such way that the given formula evaluates to true? For example, if P and Q are two Boolean variables (or atoms), P v Q can be made true by assigning true to P and false to Q. Known standard-purpose constraint solvers attempt to solve such problems from a given Boolean formula. However, in contrast to embodiments, known solvers do not generate proofs.

Further, there are numerous known interactive theorem provers. However, humans must formalize their knowledge using custom syntax to work with interactive theorem provers, and the proofs are often not in a natural, human-readable format. In contrast, embodiments are fully automated for proving theorems in propositional logic.

Embodiments allow humans to structure the proof with desired constraints. For example, consider the theorem: P implies Q is equivalent to (Not(P) Or Q). Assume that there is an additional requirement to use the Law of Excluded Middle LEM (e.g., Q or Not Q) in the proof's first step. With embodiments, a human can encode this as follows:
manual_steps=[
   (1, Formula.or_f(q, Formula.not_f(q)), LEM, []), # use q v~q
]
   Informally, this means that the first step (1) of the generated proof should be Q or Not(Q), which is a LEM rule that has no references to other step numbers, the reason for an empty array [].

Embodiments incorporate the manual steps (if any) as constraints to satisfy. In the following proof generated by embodiments, Step 1 is the LEM rule that is required as per the manual step defined above:
Premises:
   (p−>q)
Goal: (~p v q)
Length: 10
Found proof:
Step 0: (p−>q) [premise]
Step 1:(q v~q) [LEM]
Step 2:|q [assumption]
Step 3:|(~p v q) [v-i-L using 2]
Step 4:(q−>(~p v q)) [−>i using 2-3]
Step 5:|~q [assumption]
Step 6:|~p [MT using 0,5]
Step 7:|(~p v q) [v-i-R using 6]
Step 8:(~q−>(~p v q)) [−>i using 5-7]
Step 9:(~p v q) [v-e using 1,4,8]

Unlike direct SMT-based verification, the constraint-based proof search technique in accordance to embodiments produces genuinely human-readable proofs in natural deduction style. This is because the proof is constructed within a natural deduction system that mirrors how humans reason about logic. Embodiments use standard logical inference rules (e.g., modus ponens or conjunction introduction) that correspond to familiar reasoning patterns. Embodiments correctly manage assumptions and sub-proofs with proper scope handling, producing proofs with clear logical structure. By finding the shortest possible proofs, embodiments avoid unnecessary complexity that would reduce readability. Further, in embodiments, each step in the generated proof includes explicit justification, showing which prior steps and which inference rule were used.

This readability advantage allows embodiments to implement and incorporate practical applications, including: (a) explainable AI: the approach aligns with the growing need for AI systems that can explain their reasoning; (b) formal verification: proofs can be audited and verified by human reviewers; (c) mathematical communication: results can be shared with and understood by the broader mathematical community; (d) trustworthiness: the reasoning process is transparent rather than opaque; and (e) education: generated proofs can be used as teaching examples or practice solutions.

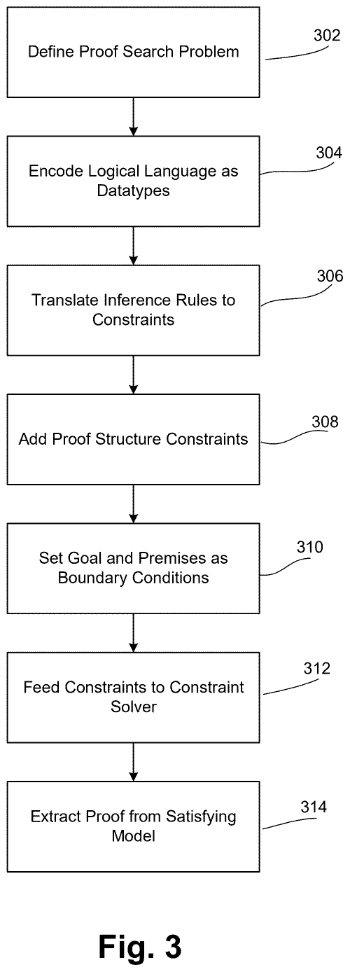

FIG. 3 is a flow diagram of the functionality of automated deductive reasoning system 10 of FIG. 1 when performing deductive reasoning in accordance to embodiments. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 302, embodiments begin by defining the proof search parameters. This includes specifying the logical premises, the goal formula to be proven, the set of allowed inference rules, and the maximum proof length. These parameters frame the search space for the constraint solver and determine the complexity of the problem.

At 304, embodiments encode logical language as datatypes by transforming logical formulas into algebraic datatypes that the constraint solver can manipulate. Propositional variables, logical connectives (AND, OR, NOT, IMPLIES), and proof steps are all encoded as structured data objects. Embodiments create recursive datatype sorts for formulas (e.g., atoms, conjunction, disjunction, negation, implication) and steps (e.g., formula steps and contradiction steps). This encoding allows the solver to reason about formulas symbolically rather than just syntactically, enabling it to track relationships between different parts of formulas.

At 306, embodiments translate inference rules to constraints. Each logical inference rule (e.g., conjunction elimination or modus ponens) is encoded as a set of constraints. These constraints specify the relationships between source formulas and the resulting formula when the rule is applied. For example, the AND-elimination rule is encoded as constraints that ensure if step i uses AND-elimination on step j, then the formula at step i must be one of the conjuncts from step j. Implication introduction requires step j to be an assumption and step k to be within the same sub-proof level.

At 308, embodiments add proof structure constraints. In addition to logical rules, system 10 needs constraints that enforce the structure of a valid proof. These include temporal constraints (e.g., a step can only reference earlier steps), accessibility constraints (e.g., a step can only reference steps that are in scope), and box-level constraints (e.g., for managing assumptions and sub-proofs). Together, these ensure that the generated proof follows the proper structure of natural deduction.

At 310, embodiments sets goal and premises as boundary conditions. Boundary conditions establish that the first steps in the proof must be the given premises, and the final step must be the goal formula. These constraints anchor the proof search, defining the starting point and endpoint that the solver must connect through valid inference steps.

At 310, in embodiments, there are two scenarios: (A) the user is defining a number of steps that is smaller than the required number of steps; or (B) the user is defining a number of steps that is larger than the required number of steps.

In the first scenario, disclosed in more detail below, the functionality will terminate with an error message such as “no proof found.” In that case, the user can increase the number of steps and rerun the functionality. In other embodiments, multiple threads can be executed, with each thread configured with a different number of steps. For example, if the user believes there is likely a proof which may take 12 to steps, four threads can be executed, each with the maximum number of steps of 12, 13, 14, and 15, respectively.

The second scenario is handled by in embodiments by generating frivolous steps that are logically correct but are not needed. For example, consider the below proof of 6 steps to prove the goal from the given premises. This proof is optimal in terms of the number of steps required to prove.
Premises:
((A−>C) \hat{ }(B−>C))
Goal: ((A v B)−>C)
Length: 6
Found proof:
Step 0:((A−>C) \hat{ }(B−>C)) [premise]
Step 1:|(A v B) [assumption]
Step 2:|(B−>C) [\hat{ }e-R using 0]
Step 3:|(A−>C) [\hat{ }e-L using 0]
Step 4:|C [v-e using 1,3,2]
Step 5:((A v B)−>C) [−>i using 1-4]

However, when the proof is rerun the same with the maximum step length of 8 (instead of 6), embodiments generate two frivolous steps, step 2 and step 3, that can be ignored because these two steps do not contribute to other steps that are necessary for the proof. As shown below, steps 2 and 3 are logically correct, but they are not needed:
Premises:
   ((A−>C) \hat{ }(B−>C))
Goal: ((A v B)−>C)
Length: 8
Found proof:
Step 0: ((A−>C) \hat{ }(B−>C)) [premise]
Step 1: (B−>C) [\hat{ }e-R using 0]
Step 2: (((A−>C) \hat{ }(B−>C)) \hat{ }((A−>C) \hat{ }(B−>C))) [\hat{ }i using 0,0]
Step 3: ((((A−>C) \hat{ }(B−>C)) \hat{ }((A−>C) \hat{ }(B−>C))) v ~(A \hat{ }A)) [v-i-R using 2]
Step 4:|(A v B) [assumption]
Step 5:|(A−>C) [\hat{ }e-L using 0]
Step 6:|C [v-e using 4,5,1]
Step 7: ((A v B)−>C) [−>i using 4-6]

In one embodiment, the extra steps are automatically removed before outputting the proof by constructing a dependency graph among the steps and locating disconnected components that do not reach to the goal. A reachability analysis can also be used to automatically remove the extra steps.

At 312, the entire system of constraints is passed to a general-purpose constraint solver, such as the “Z3” SMT solver. The solver then searches for an assignment of values to variables that satisfies all constraints simultaneously. This effectively searches for a sequence of proof steps that constitutes a valid proof from the premises to the goal. Modern SMT solvers use sophisticated algorithms to efficiently explore the search space.

At 314, embodiments extract the proof from satisfying the model. If the solver finds a satisfying assignment, this assignment represents a valid proof. The algorithm extracts the sequence of steps, rule name, etc., to construct a human-readable proof. If no satisfying assignment exists, this indicates that no proof of the specified length is possible using the allowed rules. Additional details of the functionality of FIG. 3 are disclosed below.

### Input Specification

The input specification for embodiments at 302 is as follows:
Premises: A set of logical formulas P₁, P₂, . . . , Pₙ.
Goal: A target formula G to be proven.
Proof Length: Maximum number of steps L.
Allowed Rules: Optional set of inference rules R allowed in the proof.
Manual Steps: Optional partial proof steps to include.

### Data Structure Creation

Embodiments at 304 represent propositional formulas using inductive datatypes that are supported by the “SMT-LIB Standard”. Embodiments incorporate two datatypes (i.e., sorts) to represent logical formulas and contradiction, respectively. Logical formulas typically use logical operators such as AND, OR, IMPLIES, etc. A logical formula can be just a simple propositional variable (i.e., an atom). A contradiction is a special datatype to model the scenario that have both formula f and Not (formula f) as part of the proof steps.

In general, embodiments create the data structure as follows:
Create inductive datatypes for formulas: atom(id), and_f(left, right), or_f(left, right), implies(left, right), not_f(arg).
Create datatype for contradiction: contra
Create datatype for proof steps: formula_step(f) or contra_step(c). A step in the proof can be a formula f or a contradiction c.

### Initialize Symbolic Variables

Embodiments are based on symbolic constraints. Therefore, at 306, embodiments define symbolic variables that are needed for proof generation. Each step contains the name of the rule from the allowed rules set, the source step numbers that are used by step i. Since hierarchical proofs (i.e., boxes) are supported, with assumptions, box levels are also symbolically modeled. Each step of the proof is a symbolic variable that are modeled as follows:

For each proof step i from 0 to L-1:
steps[i]: The formula or contradiction at step i
rules[i]: The inference rule applied at step i
src1[i], src2[i], src3[i]: Indices of source steps (−1 if not used)
box_level[i]: Subproof nesting level for step i

### Constraint Building Process

After the symbolic variables are identified and initialized, embodiments initialize at 308 the different types of constraints needed for proof generation.

### Initialize Premise Constraint:

Since premises are part of the proof, embodiments add a constraint that all the first n premises are the first n steps of the generated proof. Each step has the rule name initialize to PREMISE type. Since premises do not refer to other premises, the source line numbers are all initialized to −1. Because all premises are at the root level of the proof hierarchy, reason for box levels are initialized to ROOT_LEVEL constant.

For each premise Pⱼ at position j<n:
steps[j]=formula_step(Pⱼ)
rules[j]=PREMISE
src1[j]=src2[j]=src3[j]=-1
box_level[j]=ROOT_LEVEL

### Initialize Goal Constraint:

For a proof of max length L, embodiments add a constraint that the last step is indeed the goal or conclusion. Since step numbers are indexed from zero, steps[L-1] shall be the goal G. Also, the final step shall be at the root level of the hierarchy, the reason that box_level[L-1] is set to ROOT_LEVEL: steps[L-1]=formula_step(G) if G is a formula, or contra_step(contra) if G is a contradiction box_level[L-1]=ROOT_LEVEL

### Box Level Constraints:

Because embodiments support sub-proofs, constraints are added on how the proof steps are placed into the right sub-proof box. For example, since an assumption needs to be placed in a new box which is one level under its parent box, a constraint is added that box_level[i]=box_level[i-1]+1. Similarly, when an assumption box is closed using rules such as IMPLIES INTRO, NOT_INTRO, PBC, a constraint is added that the box level of the new step i is one level smaller than the previous step i-1. That is, box_level[i]=box_level[i-1]−1. For all other rules, the box levels do not change. This notion is formalized as follows:

For each proof step i from 0 to L-1

If rules[i]∈{ASSUMPTION} then box_level[i]=box_level[i-1]+1

If rules[i]∈{IMPLIES_INTRO, NOT_INTRO, PBC} then box_level[i]=box_level[i-1]−1

If rules[i]∉{ASSUMPTION, IMPLIES_INTRO, NOT_INTRO, PBC} then box_level[i]=box_level[i-1]

### Inference Rule Constraints:

For proof generation, embodiments use the basic rules of logic. Constraints need to be defined on when a rule can be applied. There are four types of rules in embodiments:
(1) The first type of rules (named as the zero-source rule) defines the constraints for rules that do not have dependencies on different steps thus the src array is initialized to −1. For example, an ASSUMPTION rule can be introduced at any step i. The assumption constraint must symbolically generate a formula f.
(2) The second type of rules (named as the single-source rule) defines the constraints for rules that depend on one of the previous steps. For example, at steps[i] the AND_ELIM rule can be applied if there exists a step j, where j<I, and the steps[j] is an AND formula.
(3) The third type of rules (named as the two-source rule) defines the constraints for rules that depend on two of the previous steps. For example, at steps[i] the AND_INRTRO rule can be applied if there exists j and k such that j<i, k<I, steps[i]=steps[j] AND steps[k].
(4) Finally, the fourth type of rules (named as the third-source rule) defines the constraints for rules that depend on three previous steps. For example, at steps[i] the OR_ELIM rule can be applied if there exists j, k, l<I such that steps[j] is an OR formula, say, F1 OR F2, steps[k] is an implies formula, say F1 implies G, and steps[l] is also an implies formula, say F2 implies G, then steps[i] is just G.

For each proof step i from n to L-1, embodiments generate constraints for each possible rule:
a. Zero-Source Rules:
ASSUMPTION:
steps[i]=formula_step(F) for some formula F
src1[i]=src2[i]=src3[i]=−1
box_level[i]=box_level[i-1]+1
LAW OF EXCLUDED MIDDLE:
steps[i]=formula_step(or_f(F, not_f(F))) for some formula F
src1[i]=src2[i]=src3[i]=−1
b. Single-source Rules (for each previous step j<i):
AND_ELIM_L:
If steps[j]=formula_step(and_f(F₁, F₂)) then steps[i] can be formula_step(F₁)
rules[i]=AND_ELIM_L
src1[i]=j
OR_INTRO_L:
If steps[j]=formula_step(F₁) then steps[i] can be formula_step(or_f(F₁, F₂)) for any F₂
rules[i]=OR_INTRO_L
src1[i]=j
   And similar constraints for: AND_ELIM_R, OR_INTRO_R, DOUBLE_NOT_INTRO, DOUBLE_NOT_ELIM, COPY, etc.
c. Two-Source Rules (for each pair of steps j, k<i):
AND_INTRO:
If steps[j]=formula_step(F₁) and steps[k]=formula_step(F₂)
then steps[i] can be formula_step(and_f(F₁, F₂))
rules[i]=AND_INTRO
src1[i]=j, src2[i]=k
IMPLIES_ELIM (Modus Ponens):
If steps[j]=formula_step(implies(F₁, F₂)) and steps[k]=formula_step(F₁)
then steps[i] can be formula_step(F₂)
rules[i]=IMPLIES_ELIM
src1[i]=j, src2[i]=k
   And similar constraints for: NOT_ELIM, IMPLIES_INTRO, NOT_INTRO, etc.
d. Three-Source Rules (for each triple of steps j, k, l<i):
OR_ELIM:
If steps[j]=formula_step(or_f(F₁, F₂)) and
steps[k]=formula_step(implies(F₁, G)) and
steps[l]=formula_step(implies(F₂, G))
then steps[i] can be formula_step(G)
rules[i]=OR_ELIM
src1[i]=j, src2[i]=k, src3[i]=l

### Accessibility Constraints:

Because embodiments support a hierarchy of sub-proofs, a constraint is added on when a step i is allowed to access step j. An example proof generated by embodiments is shown below. The proof has several sub-proofs or hierarchies shown with a vertical line. The hierarchies are nested with multiple levels. The accessibility constraints are basically restrictions on which step j can be used by another step in the proof generation process. For example, step 3 can use step 2 because they are in the same hierarchical level. However, step 8, for example, cannot use step 3 to expand the proof because step 3 is part of a different closed box ending at step 6.
Premises:
Goal: ((B−>C)−>((~B−>~A)−>(A−>C)))
Length: 10
Found proof:
Step 0:|(B−>C) [assumption]
Step 1:||(~B−>~A) [assumption]
Step 2:|||A [assumption]
Step 3:|||~~A [~~i using 2]
Step 4:|||~~B [MT using 1,3]
Step 5:|||B [~~e using 4]
Step 6:|||C [−>e using 0,5]
Step 7:||(A−>C) [−>i using 2-6]
Step 8:|((~B−>~A)−>(A−>C)) [−>i using 1-7]
Step 9: ((B−>C)−>((~B−>~A)−>(A−>C))) [−>i using 0-8]
   Formally, for every j+1<k<i, (rules[k]==implies_intro, not_intro, or pbc)=>Not(src1[k]<=j and j<=src2[k]).

As disclosed, rules such as IMPLIES_INTRO, NOT_INTRO, or PBC (proof-by-contradiction) are only introduced after a sub-proof is completed. The above constraint makes sure that steps are properly accessed without violating the hierarchical levels of sub-proofs. Otherwise, the generated proofs will be incorrect.

### Manual Step Constraints (if Provided):

Embodiments optionally allow humans to provide hints for the proof searcher. Embodiments encode hints as constraints to the steps array. For example, a human may state that steps[2] must be an assumption, steps[3] is a LEM, etc.

For each specified manual step at index i:
Add constraints fixing steps[i], rules[i], and source indices

### Constraint Combination and Solving

Once all the constraints are defined, embodiments combine them into a single logical formula that will be submitted to the constraint solver at 312 to find a solution, which is a proof of a theorem:

Combine all constraints into a single logical formula: Premise constraints∧Goal constraint∧Box level constraints∧Inference rule constraints∧Accessibility constraints∧Manual step constraints.

### Constraint Solving and Solution Extraction and Reporting

At 312, embodiments feed the combined formula to a constraint solver and call the solver to determine satisfiability of the given constraints. If satisfiable then, embodiments extract model m from the solver.

For each step i from 0 to L-1:
Evaluate step formula: step=m. evaluate(steps[i])
Evaluate rule: rule=m. evaluate(rules[i])
Evaluate sources: s1=m. evaluate(src1[i]), etc.
Evaluate box level: level=m. evaluate(box_level[i])
   m. evaluate means exact the contract values for input from symbolic constraints. These concrete values are proof steps, rule names, source line numbers, etc.

If the constraint solver reports unsatisfiable, based on the number of steps defined, then no proof was found is reported. Otherwise, embodiments extract and report the unsatisfiable core to help diagnose why no proof exists.

For example, consider the following proof, generated using embodiments, of the Modus Tollens (“MT”) rule. The premises are A−>B, ~B, and the conclusion is ~A.
Premises:
   (A−>B)
   ~B
Goal: ~A
Length: 6
Found proof:
Step 0:(A−>B) [premise]
Step 1:~B [premise]
Step 2:|A [assumption]
Step 3:|B [−>e using 0,2]
Step 4:|#[~e using 3,1]
Step 5:~A [~i using 2-4]

If the user configured embodiments to restrict the maximum proof length to 5, instead of 6, embodiments will report that no such proof is possible using the given set of allowed rules of inference as follows:
Searching proof for: (A−>B), ~B |-~A
Premises:
   (A−>B)
   ~B
Goal: ~A
Length: 5
No proof found

### Example Cloud Infrastructure

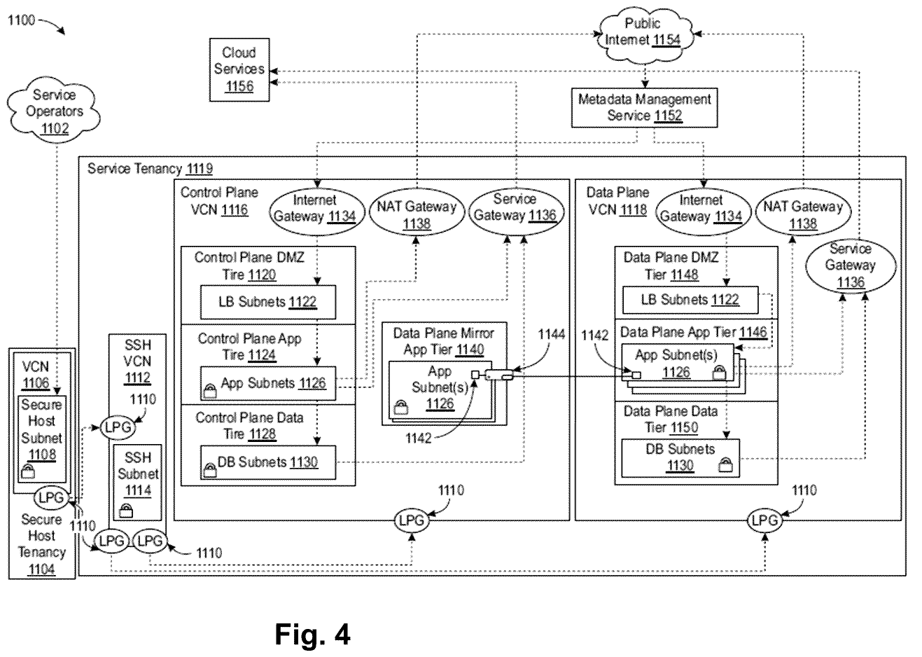

FIGS. 4-7 illustrate an example cloud infrastructure that can implement system 100 that can include automated deductive reasoning system 10 of FIG. 1 in accordance to embodiments. The use of the cloud infrastructure, as opposed to an on-premise implementation, allows for determined proofs to be used with other applications and elements, such as a ML algorithm, whether hosted on the cloud infrastructure or on-premise.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM” ), install operating systems (“OS” ) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC” ) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 4 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Meta Quest® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

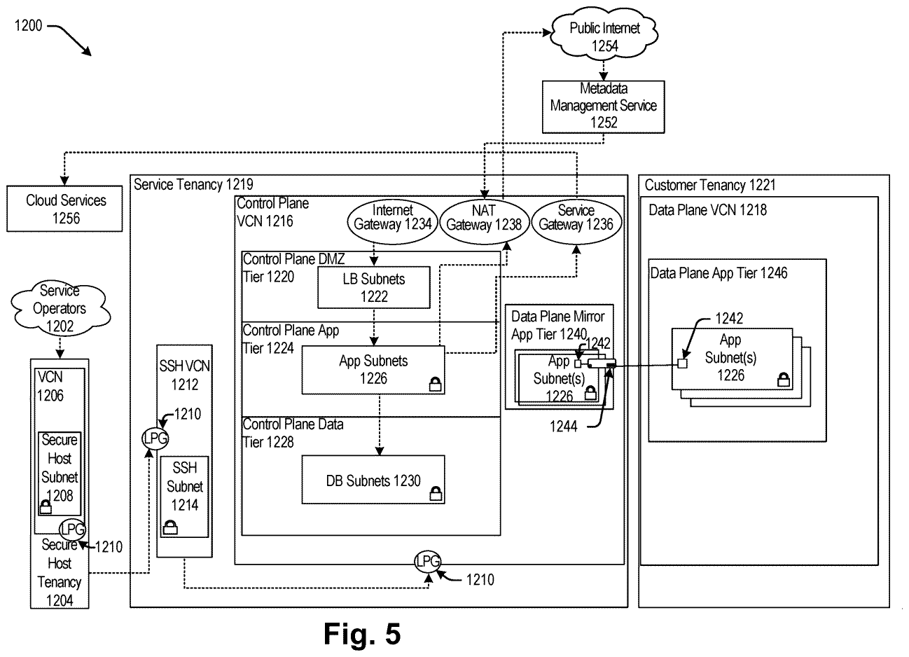

FIG. 5 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

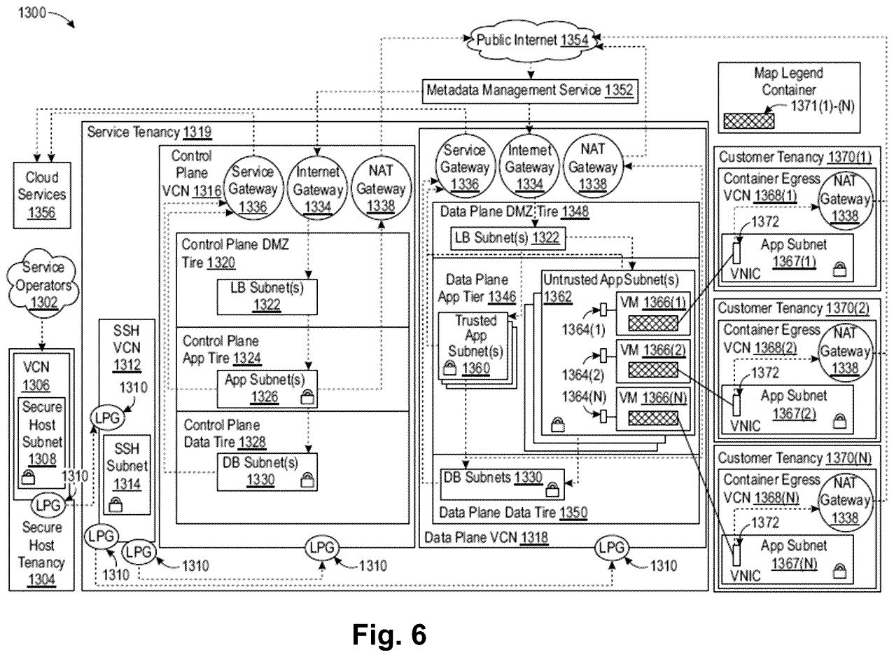

FIG. 6 is a block diagram 1300 illustrating another example pattern of an IaaS architecture, according to at least one embodiment. Service operators 1302 (e.g., service operators 1102) can be communicatively coupled to a secure host tenancy 1304 (e.g., the secure host tenancy 1104) that can include a virtual cloud network (VCN) 1306 (e.g., the VCN 1106) and a secure host subnet 1308 (e.g., the secure host subnet 1108). The VCN 1306 can include an LPG 1310 (e.g., the LPG 1110) that can be communicatively coupled to an SSH VCN 1312 (e.g., the SSH VCN 1112) via an LPG 1310 contained in the SSH VCN 1312. The SSH VCN 1312 can include an SSH subnet 1314 (e.g., the SSH subnet 1114), and the SSH VCN 1312 can be communicatively coupled to a control plane VCN 1316 (e.g., the control plane VCN 1116) via an LPG 1310 contained in the control plane VCN 1316 and to a data plane VCN 1318 (e.g., the data plane 1118) via an LPG 1310 contained in the data plane VCN 1318. The control plane VCN 1316 and the data plane VCN 1318 can be contained in a service tenancy 1319 (e.g., the service tenancy 1119).

The control plane VCN 1316 can include a control plane DMZ tier 1320 (e.g. the control plane DMZ tier 1120) that can include load balancer (“LB”) subnet(s) 1322 (e.g., LB subnet(s) 1122), a control plane app tier 1324 (e.g., the control plane app tier 1124) that can include app subnet(s) 1326 (e.g., similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g., the service gateway) and a network address translation (NAT) gateway 1338 (e.g., the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g., the data plane DMZ tier 1148), and a data plane data tier 1350 (e.g., the data plane data tier 1150). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g. the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

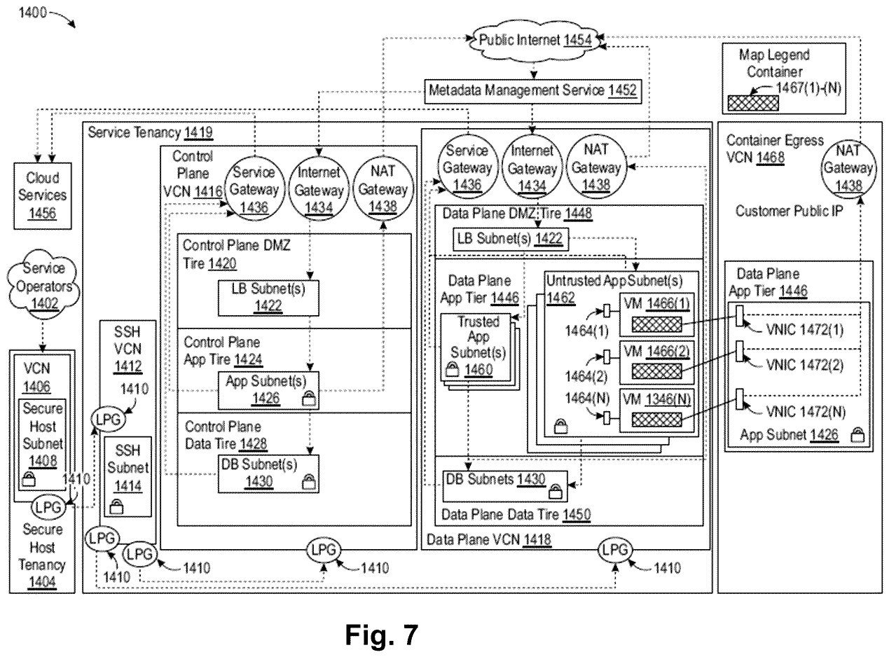

FIG. 7 is a block diagram 1400 illustrating another example pattern of an IaaS architecture, according to at least one embodiment. Service operators 1402 (e.g., service operators 1102) can be communicatively coupled to a secure host tenancy 1404 (e.g., the secure host tenancy 1104) that can include a virtual cloud network (“VCN”) 1406 (e.g., the VCN 1106) and a secure host subnet 1408 (e.g. the secure host subnet 1108). The VCN 1406 can include an LPG 1410 (e.g., the LPG 1110) that can be communicatively coupled to an SSH VCN 1412 (e.g., the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g., the control plane VCN 1116) via an LPG 1410 contained in the control plane VCN 1416 and to a data plane VCN 1418 (e.g., the data plane 1118) via an LPG 1410 contained in the data plane VCN 1418. The control plane VCN 1416 and the data plane VCN 1418 can be contained in a service tenancy 1419 (e.g., the service tenancy 1119).

The control plane VCN 1416 can include a control plane DMZ tier 1420 (e.g., the control plane DMZ tier 1120) that can include LB subnet(s) 1422 (e.g. LB subnet(s) 1122), a control plane app tier 1424 (e.g., the control plane app tier 1124) that can include app subnet(s) 1426 (e.g., app subnet(s) 1126), a control plane data tier 1428 (e.g., the control plane data tier 1128) that can include DB subnet(s) 1430 (e.g., DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 5) and a network address translation (NAT) gateway 1438 (e.g., the NAT gateway 1138). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 may be considered an exception to the pattern illustrated by the architecture of block diagram 1300 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, embodiments are directed a fully automated technique to perform logical reasoning of propositional logic in the natural deduction framework. Embodiments model the proof construction problem as a constraint satisfaction problem to systematically search for a proof. From the given set of premises and conclusion, embodiments generate a proof using the allowed list of inference rules and a maximum proof length.

Human users can configure embodiments to restrict the allowed list of inference rules and the maximum proof length. This will allow the users to discover new proofs, for example. Embodiments report an error if a proof cannot be generated for the given configuration of allowed inference rules and the maximum proof length. Embodiments support hierarchical proofs and follows strict rules of boxing to make sure the generated proofs obey the rules of hierarchies that step i cannot access step j in a different sub-proof.

Embodiments can automatically generate formulas for assumptions to generate proofs. Assumptions are often needed to prove formulas that use IMPLIES or OR logical operators. Embodiments support the law of excluded middle (“LEM”) and automatically generates relevant LEM formulas for proof generation.

Humans can also optionally provide hints in embodiments to restrict the structure of the generated proofs. For example, humans can introduce constraints to enforce that a deduction rule of their choice is used in the generated proof.

Embodiments can also verify whether the proofs written by humans are correctly using the rules of inference. The generated proofs resemble how humans would typically write proofs using the rules or axioms of the underlying logic, not always using proof-by-contradiction. Embodiments can be extended to include more rules of inference in addition to the rules present in natural deduction. Derived rules can be defined based on basic rules and configure the allowed rules to generate proofs based on derived rules, too.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of generating a proof of a problem, the method comprising:
receiving a set of premises, a corresponding conclusion, a set of rules, and a maximum proof length;
modeling each step of the proof as a variable;
representing each of the set of rules as a constraint;
delegating the constraints to a specialized constraint solver; and
when the specialized constraint solver determines a solution that simultaneous satisfies the constraints, extracting the proof, wherein the proof comprises a sequence of steps and rule names.

2. The method of claim 1, further comprising receiving a maximum proof length.

3. The method of claim 2, further comprising:
when the specialized constraint solver fails to determine a solution that simultaneous satisfies the constraints, reporting an error that no proof of the maximum proof length is possible.

4. The method of claim 1, further comprising encoding logical formulas of the proof into algebraic datatypes.

5. The method of claim 1, further comprising generating at least one of a temporal constraint, an accessibility constraint, or a box-level constraint.

6. The method of claim 1, further comprising setting boundary conditions.

7. The method of claim 1, further comprising generating law of excluded middle formulas for proof generation.

8. The method of claim 1, further comprising:
using a cloud infrastructure for generating the proof of the problem, the cloud infrastructure comprising a first virtual cloud network (VCN) comprising a local peering gateway (LPG) communicatively coupled to a secure shell (SSH) VCN via the LPG;
wherein the LPG is contained in a control plane VCN and the SSH VCN is communicatively coupled to a data plane VCN.

9. A non-transitory computer readable medium having instructions stored thereon that, when executed by one or more processors, cause the processors to generate a proof of a problem, the generating comprising:
receiving a set of premises, a corresponding conclusion, a set of rules, and a maximum proof length;
modeling each step of the proof as a variable;
representing each of the set of rules as a constraint;
delegating the constraints to a specialized constraint solver; and
when the specialized constraint solver determines a solution that simultaneous satisfies the constraints, extracting the proof, wherein the proof comprises a sequence of steps and rule names.

10. The computer readable medium of claim 9, the generating further comprising receiving a maximum proof length.

11. The computer readable medium of claim 10, the generating further comprising:
when the specialized constraint solver fails to determine a solution that simultaneous satisfies the constraints, reporting an error that no proof of the maximum proof length is possible.

12. The computer readable medium of claim 9, the generating further comprising encoding logical formulas of the proof into algebraic datatypes.

13. The computer readable medium of claim 9, the generating further comprising generating at least one of a temporal constraint, an accessibility constraint, or a box-level constraint.

14. The computer readable medium of claim 9, the generating further comprising setting boundary conditions.

15. The computer readable medium of claim 9, the generating further comprising generating law of excluded middle formulas for proof generation.

16. The computer readable medium of claim 9, the generating further comprising:
using a cloud infrastructure for generating the proof of the problem, the cloud infrastructure comprising a first virtual cloud network (VCN) comprising a local peering gateway (LPG) communicatively coupled to a secure shell (SSH) VCN via the LPG;
wherein the LPG is contained in a control plane VCN and the SSH VCN is communicatively coupled to a data plane VCN.

17. A problem proof generation system comprising:
a specialized constraint solver;
one or more processors coupled to the specialized constraint solver and configured to:
receive a set of premises, a corresponding conclusion, a set of rules, and a maximum proof length;
model each step of the proof as a variable;
represent each of the set of rules as a constraint;
delegate the constraints to the specialized constraint solver; and
when the specialized constraint solver determines a solution that simultaneous satisfies the constraints, extract the proof, wherein the proof comprises a sequence of steps and rule names.

18. The problem proof generation system of claim 17, the processors further configured to receive a maximum proof length; and
when the specialized constraint solver fails to determine a solution that simultaneous satisfies the constraints, report an error that no proof of the maximum proof length is possible.

19. The problem proof generation system of claim 17, the processors further configured to encode logical formulas of the proof into algebraic datatypes.

20. The problem proof generation system of claim 17, wherein the system is executed on a cloud infrastructure, the cloud infrastructure comprising a first virtual cloud network (VCN) comprising a local peering gateway (LPG) communicatively coupled to a secure shell (SSH) VCN via the LPG;
wherein the LPG is contained in a control plane VCN and the SSH VCN is communicatively coupled to a data plane VCN.
